(19) United States
(12) Patent Application Publication
(10) Pub. No.: US 2017/0004095 A1
(43) Pub. Date: Jan. 5, 2017

(54) Memory Control Circuit and Storage Device

(71) Applicant: Kabushiki Kaisha Toshiba, Tokyo (JP)

(72) Inventors: Susumu TAKEDA, Kawasaki (JP); Shinobu Fujita, Tokyo (JP)

(73) Assignee: Kabushiki Kaisha Toshiba

(21) Appl. No.: 15/266,495

(22) Filed: Sep. 15, 2016

Related U.S. Application Data
(63) Continuation of application No. PCT/JP2015/076009, filed on Sep. 14, 2015.

(30) Foreign Application Priority Data
Sep. 19, 2014 (JP) 2014-191882

(51) Int. Cl. G06F 12/14; G06F 3/06

(52) U.S. Cl. CPC G06F 12/1425; G06F 3/065; G06F 3/0685; G06F 3/0619; G06F 2212/1052

(57) ABSTRACT

A memory control circuit has a memory controller that performs access control for a first memory accessed by a first data amount and access control for a second memory of a memory layer equal to the first memory at a read speed lower than a read speed of the first memory by a second data amount larger than the first data amount.

### CROSS REFERENCE TO RELATED APPLICATIONS

This application is based upon and claims the benefit of priority from the prior Japanese Patent Application No. 2014-191882, filed on Sep. 19, 2014, the entire contents of which are incorporated herein by reference.

### FIELD

An Embodiment of the present invention relates to a memory control circuit and a storage device.

### BACKGROUND

A difference between the speeds of a main memory and a processor called a memory wall problem is still a serious problem, By using another memory (for example, a magnetoresistive RAM (MRAM)) that can be accessed at a speed higher than the speed of a dynamic RAM (DRAM) that is generally used as a main memory, an increase in the speed of the main memory is expected.

While the MRAM is superior to the DRAM from the aspect of an access speed, the MRAM tends to be inferior to the DRAM in the aspect of the degree of integration. Thus, in consideration of a recent trend of the implementation of a high capacity of a main memory, it is difficult to configure all the main memories using the MRAMs.

### BRIEF DESCRIPTION OF THE DRAWINGS

FIG. 1 is a block diagram of a memory control circuit 1 according to an embodiment of the present invention;

FIG. 2 is a block diagram that illustrates a specific example of the internal configuration of a memory controller 6;

FIG. 3 is a diagram that illustrates a unit of a data amount of access control;

FIG. 4 is a block diagram that is acquired by adding an error detecting unit 14 to the configuration of the memory controller 6 illustrated in FIG. 2;

FIG. 5 is a block diagram that illustrates a specific example of the internal configuration of an adjustment unit 11;

FIG. 6 is a diagram that illustrates the operation of the adjustment unit 11 performed in a case where there is a read request;

FIG. 7 is a diagram that illustrates the operation of the adjustment unit 11 performed in a case where there is a write request;

FIG. 8 is a schematic diagram that illustrates a CS address and a RAS address and a place accessed using the RAS address;

FIG. 9A is a diagram that illustrates a layered tag structure, and FIG. 9B is a diagram that illustrates an integrated tag structure;

FIG. 10 is a block diagram that illustrates an example of the internal configuration of a second memory 3; and

FIG. 11 is a block diagram that illustrates an example of the internal configuration of a processor system.

### DETAILED DESCRIPTION

According to one embodiment, a memory control circuit has a memory controller that performs access control for a first memory accessed by a first data amount and access control for a second memory of a memory layer equal to the first memory at a read speed lower than a read speed of the first memory by a second data amount larger than the first data amount.

Hereinafter, an embodiment of the present invention will be described with reference to the drawings. In the embodiment described below, while distinctive configurations and operations inside a memory control circuit will be focused, configurations and operations that are omitted in the following description may be present in the memory control circuit. Such omitted configurations and operations belong to the scope of this embodiment as well.

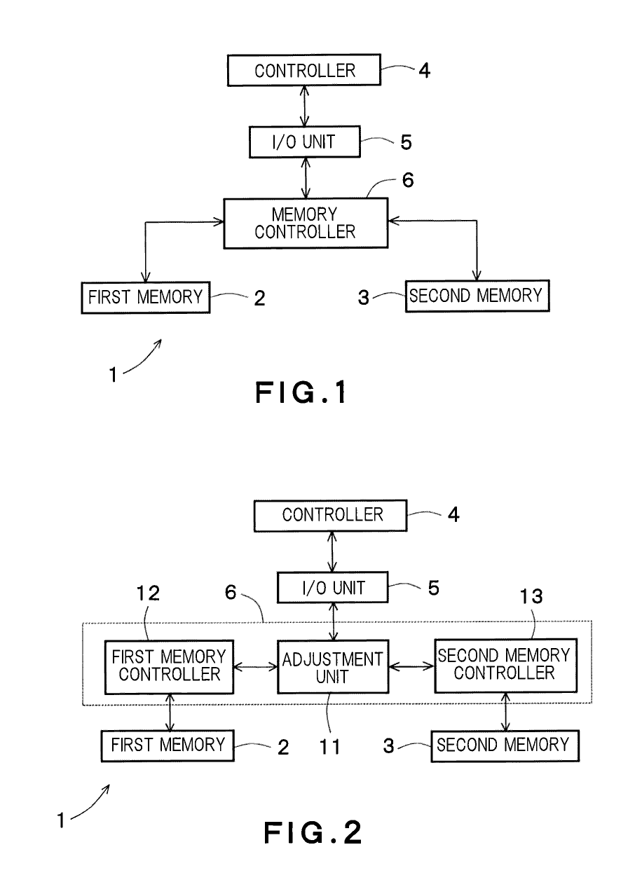

FIG. 1 is a block diagram of a memory control circuit 1 according to an embodiment of the present invention. The memory control circuit 1 illustrated in FIG. 1 controls accesses to a first memory 2 and a second memory 3. The first memory 2 and the second memory 3 are memories of a same layer. Here, the same layer represents a specific layer of a case where a memory has a layered structure of one or more layers. As a more specific example, the first memory 2 and the second memory 3 configure at least a part of a main memory. Here, generally, the main memory is a memory that is managed by basic software such as an OS. In a general computer system, the main memory is not mounted in a same die as that of a processor but is connected to the processor using an interface such as a double-data-rate SDRAM (DDR) or the like. The first memory 2 and the second memory 3 do not necessarily need to be a main memory managed by a processor. For example, the first and second memories 2 and 3 may be memories of the same layer that are accessed under the control of various memory controllers.

The first memory 2 is a memory having a reading speed higher than the second memory 3 and, for example, includes a memory cell array using an MRAM. The second memory 3 is a memory having a reading speed lower than the first memory 2 and, for example, includes a memory cell array using a DRAM. Since a DRAM can be integrated more easily than an MRAM, the memory capacity of the second memory 3 can be configured to be larger than that of the first memory 2. Here, the relation between the capacities of the first memory 2 and the second memory 3 may be reversed, or the memory capacities of both the memories may be configured to be the same.

While it is not necessary to use the MRAM as the first memory 2 and to use the DRAM as the second memory 3, hereinafter, an example will be described in which the MRAM is used as the first memory 2, the DRAM is used as the second memory 3, and the memory capacity of the second memory 3 is larger than that of the first memory 2.

A memory control circuit 1 illustrated in FIG. 1 includes a controller 4, an I/O unit (circuitry) 5, and a memory controller 6.

The controller 4 issues access requests to the first memory 2 and the second memory 3. As the access requests, there are a read request and a write request, In this embodiment, a burst access according to one command, for example, in a DDR is assumed to be regarded as one access. As burst access forms of a DDR, for example, while there are an interleave system and a sequential system, hereinafter, the sequential system will be described as the base. However, this embodiment is not limited to the sequential system. The controller 4 may be mounted in the same die as that of a processor not illustrated in the FIG. 1 or may be arranged inside a chip set that is separate from the processor. In addition, the controller 4, for example, like a direct memory access (DMA) controller, may issue access requests for the first memory 2 and the second memory 3 regardless of the processor.

The I/O unit 5 receives an access request issued by the controller 4 or data to be stored in the first memory 2 and the second memory 3 and transmits the access request or the data to the memory controller 6. In addition, the I/O unit 5 transmits data read from the first memory 2 and the second memory 3 to the controller 4. The I/O unit 5, generally, maintains a high-speed buffer such as an SRAM and temporarily stores an access request issued from the controller 4 and data read from the first memory 2 and the second memory 3 in the buffer. In this embodiment, the I/O unit 5 is not an essential constituent element. An embodiment may be implemented so that the controller 4 and the memory controller 6 deliver information not through the I/O unit 5.

The memory controller 6 performs access control for the first memory 2 and the second memory 3 in response to an access request from the controller 4. Here, the access control has a concept including control of reading data stored in the first memory 2 and the second memory 3 and control of writing data into the first memory 2 and the second memory 3.

More specifically, when there is a read request from the controller 4, the memory controller 6 performs read control for the first memory 2 and the second memory 3. The memory controller 6 specifies data stored in the first memory 2 among data for which a read request is present and transmits a read request for the specified data to the first memory 2, In addition, as is necessary, in parallel with this, a read request is transmitted also to the second memory 3.

Since the speed of the MRAM is higher than that of the DRAM, data read from the first memory 2 arrives at the memory controller 6 earlier than data read from the second memory 3. For this reason, the memory controller 6 transmits the data read from the first memory 2 to the I/O unit 5 with priority and reads remaining data not stored in the first memory 2 among data for which a read request is present from the second memory 3 and transmits the read data to the I/O unit 5. The I/O unit 5 buffers the data transmitted from the memory controller 6. The I/O unit 5 transmits buffered data to the controller 4 in accordance with a sequence defined in advance. Accordingly, in the sequence defined in advance, in a case where data to be transmitted to the controller 4 for the first time is read from the first memory 2, the data read from the first memory 2 is transmitted to the controller 4 at a speed higher than the speed at which the data read from the second memory 3 is transmitted.

On the other hand, when there is a write request from the controller 4, the memory controller 6 stores a part of data for which the write request is present in the first memory 2. In addition, the memory controller 6 stores all the data for which the write request is present in the second memory 3 after completion of writing of the data in the first memory 2 or in the middle of writing the data.

FIG. 2 is a block diagram that illustrates a specific example of the internal configuration of the memory controller 6, The memory controller 6 illustrated in FIG. 2 includes an adjustment unit (circuitry) (access control unit (circuitry)) 11, a first memory controller 12, and a second memory controller 13.

The adjustment unit 11 receives from the I/O unit 5 an access request issued from the controller 4 and controls an access to one of the first memory controller 12 and the second memory controller 13. In other words, the adjustment unit 11 performs control of storing a part of data for which a write request from the controller 4 is present in the first memory 2 and control of storing all the data in the second memory 3. More specifically, the adjustment unit 11 determines whether or not the data for which the read request is present is stored in the first memory 2 and performs read control for the first memory 2. In addition, at the time of reading data, the adjustment unit 11 performs adjustment of the data read from the first memory 2 and the second memory 3 and transmits the read data to the I/O unit 5. Furthermore, at the time of writing data, the adjustment unit 11 instructs the first memory controller 12 and the second memory controller 13 to write the data.

The first memory controller 12 performs access control for the first memory 2 by using a first data amount as the unit. The second memory controller 13 performs access control for the second memory 3 by using a second data amount larger than the first data amount as the unit,

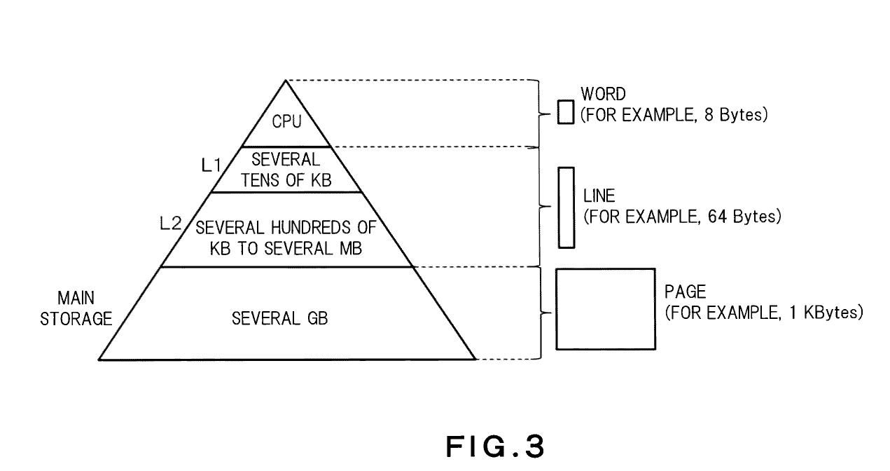

The first data amount, for example, is a word unit. The second data amount, for example, is a line unit, FIG. 3 is a diagram that illustrates a unit of a data amount of access control, Generally, as the main memory, a DRAM memory array is used, and an access to the DRAM memory array is performed in units of pages of about 1 k bytes. The main memory is connected to the controller 4 through an interface such as a DDR, and data read from the main memory or write data transmitted from the controller 4 is transmitted in a data input/output width of about 64 bits. Data of about 64 bits that is delivered in transmission of one time is called a word. On the other hand, an access to a cache memory in which data stored in the main memory or a part of data to be stored in the main memory is stored is performed in a line unit of about 64 bytes. In addition, the processor issues a data access request for data of 32 bits (4 bytes), 64 bits (8 bytes), or the like. In this embodiment, data of 64 bits is assumed.

When, mainly, a cache miss occurs, in order to fill the cache memory with data, the processor reads data of about 64 bytes into the main memory through the controller 4. At this time, a general processor transmits an access request to the main memory through the controller 4 such that data used in a nearest operation is transmitted first. Accordingly, the processor can perform an operation without waiting for the completion of transmission of data of 64 bytes according to a main memory access. A word that is transmitted first from the main memory is called a critic& word. In this embodiment, by setting the first data amount to one word and setting the second data amount to one line, access control of small-capacity data is performed for the first memory 2, and access control of large-capacity data for one time is performed for the second memory 3.

More specifically, in the second memory 3 configured using a DRAM, all the data for which a write request is present is stored, and a part of the data is stored in (copied to) the first memory 2 configured using an MRAM.

In this way, a main reason for redundantly storing data stored in the first memory 2 also in the second memory 3 is that the occurrence frequency of a bit error is higher in the MRAM than in the DRAM. In a case where all the data is stored in the DRAM, even when a bit error occurs in data stored inside the MRAM, data read from the DRAM is returned to a read request destination, and accordingly, here is no problem in the operation.

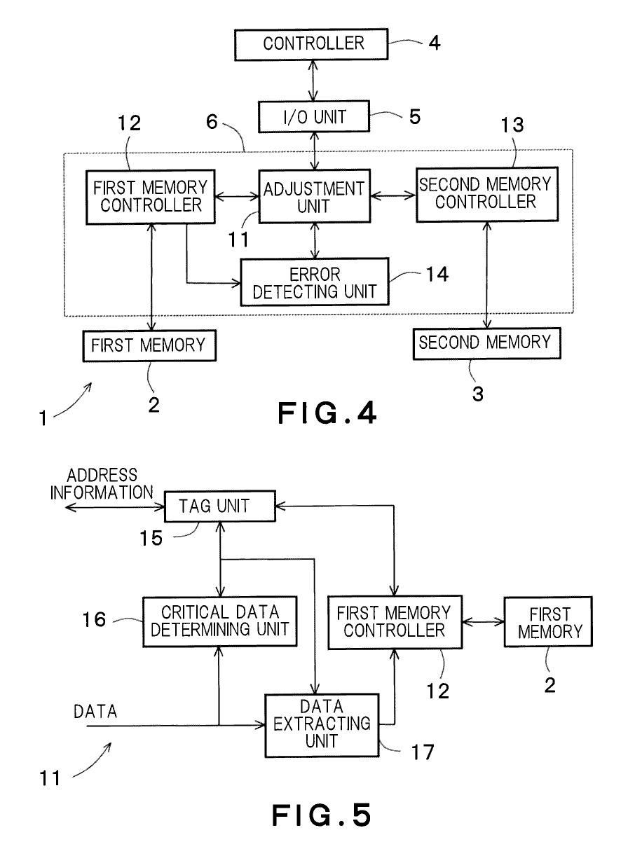

Thus, as illustrated in FIG. 4, it is preferable to add an error detecting unit (circuitry) 14 to the configuration of the memory controller 6 illustrated in FIG. 2. The error detecting unit 14 illustrated in FIG. 4 detects whether or not there is a bit error in data read from the first memory 2 configured using an MRAM. A result of the detection of a bit error acquired by the error detecting unit 14 is transmitted to the adjustment unit 11. When there is no bit error, the adjustment unit 11 returns the data read from the first memory 2 and the remaining data read from the second memory 3 to the controller 4. On the other hand, when there is a bit error, the data read from the first memory 2 is ignored, and all the data read from the second memory 3 is returned to the controller 4. In this way, when a bit error is detected by the error detecting unit 14, the data stored inside the first memory 2 is not used, and thus, an error correcting unit does not need to be arranged. An error correcting process requires a processing time longer than the processing time of an error detecting process and becomes a factor decreasing the speed of reading data from the first memory 2. In this embodiment, only error detection is performed, and accordingly, the speed of reading data from the first memory 2 can be increased.

In the case illustrated in FIG. 4, while the error detecting unit 14 is arranged to be separate from the adjustment unit 11 and the first memory controller 12, the error detecting unit 14 may be arranged inside the adjustment unit 11 or the first memory controller 12.

The first memory 2 is intended to narrow down and store data for which a latency is important, and, although the memory capacity of the first memory 2 is lower than that of the second memory 3, the first memory 2 can store a many data quantity, and the use efficiency of the first memory 2 can be raised. For example, by storing a critical word in the first memory 2, an access request from the processor can be responded in a speedy manner.

FIG. 5 is a block diagram that illustrates a specific example of the internal configuration of the adjustment unit 11. The adjustment unit 11 illustrated in FIG. 5 includes a tag unit (circuitry) 15, a critical data determining unit (circuitry) 16, and a data extracting unit (circuitry) 17.

The tag unit 15 stores address information corresponding to data stored in the first memory 2. In addition, the tag unit 15 performs a hit/miss determination for determining whether or not address information input from the I/O unit 5 at the time of reading data matches address information stored in the tag unit 15. In this way, the tag unit 15 specifies data stored in the first memory 2 based on the input address information.

The critical data determining unit 16 determines whether or not a part of data for which an access request is present is to be stored in the first memory 2. The critical data determining unit 16 determines data to be stored in the first memory 2 based on a predetermined policy. A specific example of this policy will be described later.

The data extracting unit 17 extracts data to be stored in the first memory 2 among data for which a write request is present based on the determination performed by the critical data determining unit 16, transmits the data to the first memory controller 12, and transmits all the data for which the write request is present to the second memory controller 13.

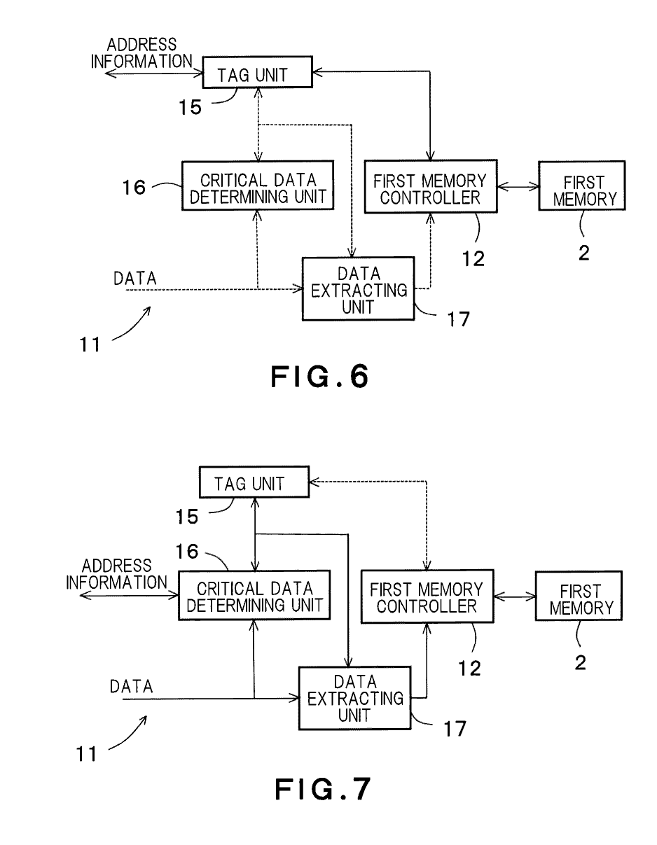

FIG. 6 is a diagram that illustrates the operation of the adjustment unit 11 performed in a case where there is a read request. In FIG. 6, the flow of signals relating to a read process is denoted by solid lines, and the flows of the other signals are denoted using broken lines. At the time of reading data, address information of data to be read is input from the I/O unit 5 to the tag unit 15, In a case where the address information for which a read request is present matches the address information stored in the tag unit 15, the tag unit 15 instructs the first memory controller 12 to read data. In accordance with this instruction, the first memory controller 12 reads the corresponding word data from the first memory 2.

FIG. 7 is a diagram that illustrates the operation of the adjustment unit 11 performed in a case where there is a write request. In the case illustrated in FIG. 7, the flow of signals relating to a write process is denoted using solid lines, and the processes of the other signals are denoted using broken lines. At the time of writing data, address information and write data to be written are input from the I/O unit 5. The address information is input to the critical data determining unit 16. The critical data determining unit 16 specifies critical data to be stored in the first memory 2 based on a policy determined in advance. Here, the critical data, for example, is data for which an access delay time has a great influence on the performance of the processor. For example, the critical word described above is critical data.

As the policy used by the critical data determining unit 16, various policies may be considered. For example, a policy of selecting data that has a high possibility of being a critical word may be considered. Here, the data having a high possibility of being a critical word, for example, is a data having a high frequency of being a critical word.

For example, by utilizing a characteristic that an address on a further start side inside a page easily tends to be a critical word, it may be considered to store several words from the start as critical data in the first memory 2. In such a case, since a start address of a page is uniquely determined at the time of designing a main memory, data stored in the first memory 2 can be easily specified. For example, in a case where the first memory 2 having a capacity storing the number of words defined in advance from the start of each of all the pages stored in a DRAM is provided, information stored in the tag unit is set at the time of designing the memory and does not need to be rewritten. In other words, the cost for designing the tag unit can be reduced. On the other hand, in a case where the first memory 2 having a capacity storing the number of words or the number of lines defined in advance from the start of each of all the pages stored in a DRAM is not provided, it is preferable to arrange a tag unit that can dynamically rewrite data at the time of operating the main memory.

The address information of the specified critical data is transmitted to the tag unit 15 and the data extracting unit 17. The tag unit 15 manages the address information transmitted from the critical data determining unit 16 as address information corresponding to the data stored in the first memory 2. The data extracting unit 17 extracts critical data corresponding to the address information among the data to be written based on the address information of the critical data. Then, the data extracting unit 17 instructs the first memory controller 12 to store the critical data.

In the policy of determining the critical data requiring the tag unit that can dynamically rewrite data (a case where the first memory 2 having a capacity storing all the critical data of the entire page is not provided), a case may be considered in which there is no change in data to be stored in the second memory 3, but there is a change in data to be stored in the first memory 2. In such a case, the data may be written only in the first memory 2 without performing data writing for the second memory 3. For example, at the time of performing a read access, it may be configured such that a word disposed at the start of a page is read, and, in a case where the data is not stored in the first memory 2, the address information of the data is recorded into the tag unit, and the data is written into the first memory 2.

In a case where the first memory 2 and the second memory 3 described above are used as a main memory, it is important to maintain compatibility with an existing main memory. An existing main memory is designed in compliance with the standard of a double-data-rate (DDR SDRAM), In the DDR, the position of a memory to be accessed is uniquely specified by using a chip select (CS) address, a row address select (RAS) address, and a column address select (CAS) address. The CS address is address information that specifies a memory cell array to be accessed. The RAS address is address information that specifies a row to be accessed. The CAS address is address information that specifies a column to be accessed.

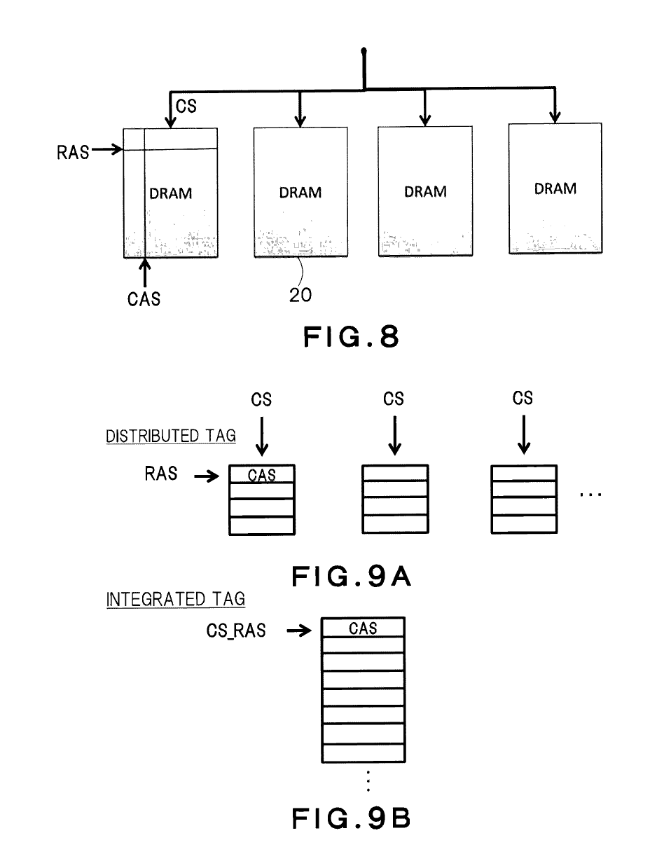

FIG. 8 is a schematic diagram that illustrates a CS address and a RAS address and a place accessed using the RAS address. FIG. 8 illustrates an example in which a main memory is configured by a plurality of DRAM chips 20. The CS address selects one DRAM chip 20. The CS address may be configured to select one memory bank. In such a case, each of four blocks illustrated in FIG. 8 illustrates a memory bank. The RAS address selects one row inside one DRAM chip (or a memory bank) 20 selected by the CS address. The CAS address selects one column inside the row selected by the RAS address, Hereinafter, as an example, an embodiment using such address information will be illustrated.

In a case where the first memory 2 and the second memory 3 described above are arranged inside the main memory and are in compliance with the standard of the DDR, information that can be used for uniquely specifying presence/absence of data in the first memory 2 based on the information of the CS address, the RAS address, and the CAS address as the address information of the data stored in the first memory 2 is stored in the tag unit 15. As mounting forms of the tag unit 15, for example, there is a permanent tag as a form in which rewriting is not performed from the time of designing the main memory, and a distributed tag structure illustrated in FIG. 9A and an integrated tag structure illustrated in FIG. 9B are considered as forms in which rewriting is dynamically performed.

As a mounting form of the permanent tag, there is a method of determining whether or not an address is a start address of a page based on the CAS address, For example, in a case where addresses are sequentially assigned to byte data belonging to a page from the start such as 0, 1, 2, . . . , when the CAS address of a critical word is “0”, a start address of a page can be specified.

The distributed tag structure, for example, maintains a tag memory for each chip selected by the CS. For example, as illustrated in FIG. 9A, by referring to the tag using a RAS address and performing a comparison with a read CAS address, data storage/non-storage for the first memory 2 is determined. Alternatively, for example, by referring to the tag using a CAS address and performing a comparison with a read RAS address, data storage/non-storage for the first memory 2 is determined.

Meanwhile, in the case of the integrated tag structure illustrated in FIG. 9B, for example, by referring to the tag using an address acquired by integrating a CS address and a RAS address and performing a comparison with a read CAS address, data storage/non-storage for the first memory 2 is determined. For example, by referring to the tag using an address acquired by integrating a CS address and a CAS address and performing a comparison with a read RAS address, data storage/non-storage for the first memory 2 is determined.

The distributed tag can decrease the size of a tag accessed for one time to be less than that of the integrated tag and thus tends to enable a tag access at a high speed. On the other hand, according to the integrated tag, an embodiment in which the number of pieces of data that is different for each chip is stored in the first memory 2 can be relatively easily mounted. In a case where the numbers of pieces of critical data are different between chips, the integrated tag enables efficient storage of the critical data.

Such a tag unit can be combined with a technology that is generally used in a cache memory, a TLB, or the like. For example, the tag unit can be combined with a set associative system. For example, as in the TLB, the tag memory may be layered.

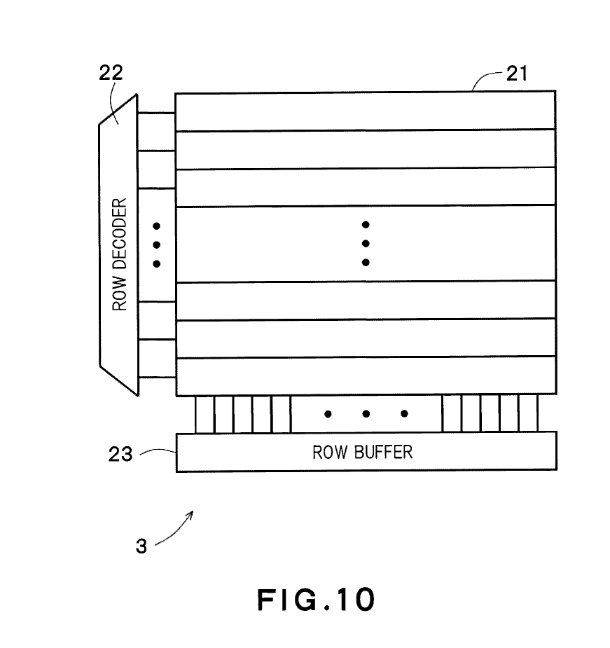

The second memory 3 configured using a DRAM can be formed in a structure similar to the structure of a general-purpose DRAM module. FIG. 10 is a block diagram that illustrates an example of the internal configuration of a memory module including the second memory 3. The second memory 3 illustrated in FIG. 10 includes a DRAM array 21, a row decoder 22, and a row buffer 23. The DRAM array 21, for example, includes rows each corresponding to 1 k bytes that is page data. The row decoder 22 selects a specific row by decoding a RAS address. The row buffer 23 is a high-speed memory such as an SRAM and stores data of a specific row selected by the row decoder 22.

A process of storing a specific row in the row buffer 23 is called activation. Hereinafter, an activated DRAM chip (or memory bank) will be referred to as a bank of an active state (active bank). For an active bank, data reading or data writing can be performed. In order to access a different row, it is necessary to invalidate data stored in the row buffer 23 by writing back data stored in the row buffer 23 into the DRAM chip (or the memory bank). This process is called pre-charging. A pre-charged DRAM chip (or memory bank) will be referred to as a bank of an idle state (idle bank). Generally, only the idle bank can be activated. In addition, after an elapse of a constant time or after the pre-charging, the active bank transits to an idle bank. In other words, data written into the row buffer, after an elapse of the constant time or in a case where pre-charging is performed, is written into the second memory 3 in units of pages each being the second data amount.

In the standard of a general DDR, an access is performed by issuing a command to the DRAM module. Generally, commands used for giving instructions for activation, reading, writing, and pre-charging are provided.

### (Access Sequence in Idle State)

Hereinafter, an example of the processing sequence performed at the time of reading data will be described in a case where an activation command and a burst read command of 8 words (64 bytes) are issued by the controller 4 when the second memory 3 is in the idle state. Here, one word is assumed to be 8 bytes, and one page is assumed to be 1 k bytes. In addition, critical data is assumed to be a first one word of a page. A first memory 2 configured by an MRAM having a capacity storing critical data of all the data stored in a second memory 3 configured by a DRAM is assumed to be provided. In this case, since it can be specified whether or not data is stored in the first memory 2 based on address information for which a read request is present, a tag memory that can dynamically perform rewriting does not need to be arranged in the tag unit 15 inside the memory controller 6. In addition, in data stored inside the first memory 2 configured by using the MRAM, a bit error is assumed to occur at a constant probability, and the memory controller 6 is assumed to include the error detecting unit 14.

The adjustment unit 11 receives an activation command and a burst read command from the I/O unit 5 and transmits the commands to the second memory controller 13. The second memory controller 13, similarly to the operation of a general DDR, performs activation and then reads accessed data from the row buffer 23, In parallel with this, the tag unit 15 checks whether or not a critical word of burst data designated in the burst read command is stored in the first memory 2. Here, this is checked using the permanent tag.

In this way, in a case where only the start address inside a page is stored in the first memory 2, by only checking whether or not the start address inside the page is included in data for which a read request is present without comparing address information using the tag memory, it can be determined whether or not corresponding data is stored in the first memory 2. In the case of such a tag unit 15, data storage/non-storage can be determined at a high speed.

In a case where a critical word for which a read request is present is not the start inside the page, the adjustment unit 11 transmits the data read from the second memory 3 to the I/O unit 5.

On the other hand, in a case where the critical word for which the read request is present is the start inside the page, the adjustment unit 11 instructs the first memory controller 12 to read corresponding data stored inside the first memory 2. Since the reading speed of the MRAM is higher than that of the DRAM, reading data from the first memory 2 is completed earlier than the reading data from the second memory 3.

The error detecting unit 14 detects whether or not a bit error is present in the data read from the first memory 2. Based on a result of the detection acquired by the error detecting unit 14, in a case where there is no bit error, the adjustment unit 11 transmits the data read from the first memory 2 to the I/O unit 5. Thereafter, the second memory controller 13, based on activation and read commands, transmits burst data corresponding to 64 bytes from the second memory 3 and transmits the read data to the adjustment unit 11. The adjustment unit 11 transmits data corresponding to 56 bytes acquired by excluding the data corresponding to 8 bytes transmitted to the I/O unit 5 in advance among data corresponding to 64 bytes transmitted from the second memory 3, to the I/O unit 5.

On the other hand, in a case where a bit error is detected by the error detecting unit 14, the adjustment unit 11 transmits the data corresponding to 64 bytes read from the second memory 3 to the I/O unit 5 without performing the process of transmitting the data read from the first memory 2 to the I/O unit 5.

In a case where a bit error is detected, the adjustment unit 11 may instruct the first memory controller 12 to overwrite data corresponding to the start address of the data corresponding to 64 bytes read from the second memory 3 into the first memory 2.

Next, an example of the processing sequence performed at the time of writing data will be explained in which an activation command and a burst write command of four words (64 bytes) are issued by the controller 4 when the second memory 3 is in the idle state. In a case where data is written into a main memory, the adjustment unit 11 checks whether or not data of a start address of a page is included in the write data and instructs the first memory controller 12 to write the data of the start address into the first memory 2 in a case where the data is included. In addition, the adjustment unit 11 receives an activation command and a burst write command from the I/O unit 5 and, similarly to the operation of a general DDR, performs activation and then writes data of 64 bytes into the row buffer. After the writing process, page data on the row buffer is written into the DRAM array after execution of a pre-charge command or after an elapse of a constant time.

### (Access Sequence in Active State)

In the access sequence performed in the idle state described above, an example has been illustrated in which a read command or a write command is issued following an activation command in the idle state of the second memory 3, Meanwhile, there are cases where an access request is issued for an active bank of the second memory 3. In such cases, the processing sequence is different based on whether or not data for which the access request is present is included in a row of the active state.

In a case where the data for which the access request is present is not included in the row of the active state, the controller 4 issues a pre-charge command before issuing an access request command. After transmitting the pre-charge command to the second memory controller 13 and causing the second memory 3 to transit to the idle state, the adjustment unit 11, similarly to the access sequence performed in the idle state, may perform read control or write control for the first memory 2 and the second memory 3.

On the other hand, in a case where data for which the access request is present is included in the row of the active state, the row of the active state is stored in the row buffer 23 configured using an SRAM or the like having a speed higher than a DRAM, and accordingly, the data stored in the row has a high possibility of being read at a speed higher than the speed of the first memory 2 configured by using an MRAM. Accordingly, in a case where the row buffer 23 is arranged inside the second memory 3, and a read access is performed, an access may be performed only for the memory module including the second memory 3 without accessing the first memory 2. Alternatively, in order to configure the access sequence to be common, accesses may be performed for both the first memory 2 and the second memory 3 in the same sequence as the access sequence performed in the idle state.

Generally, an access command used for accessing the main memory is temporarily stored in the buffer. The adjustment unit 11, for example, refers to the buffer storing an access command used for accessing the main memory arranged in the I/O unit and can identify an access sequence for an idle bank or an access sequence for an active bank based on whether or not the access request command is paired with an activation command. The adjustment unit can determine whether or not an access to the first memory 2 is necessary based on this identification information.

In the embodiment described until now, an example has been illustrated in which a first word in a page is set as critical data as the policy for selecting critical data. However, this embodiment is not limited to such an example. As the polity for selecting critical data, various policies other than the policy of the embodiment may be considered.

For example, a critical word of access data of each time may be set as the critical data, or data having a high frequency to be a critical word may be set as the critical data based on a history of a plurality of number of accesses. In addition, a critical word of an access causing a row buffer miss (read for the idle state) may be set as the critical data. In such a case, since the critical data may be various kinds of data, it is preferable to arrange a tag unit capable of dynamically rewriting data.

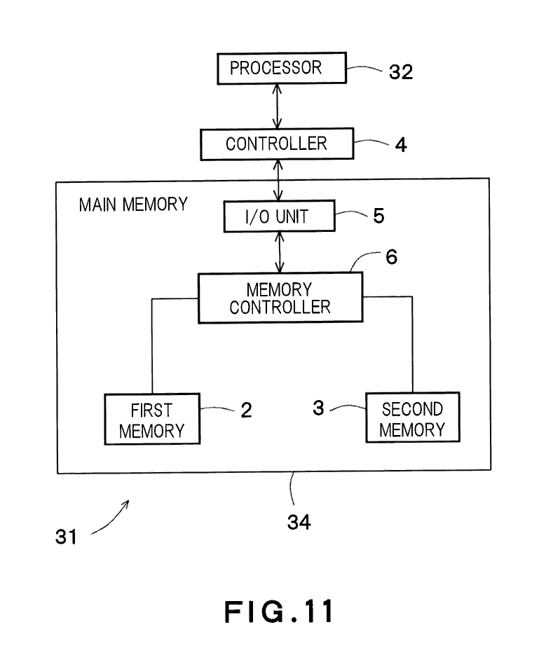

A processor system of a case where the first memory 2 and the second memory 3 described above are used as a main memory, for example, is represented by a block diagram as illustrated in FIG. 11. The processor system 31 illustrated in

FIG. 11 includes a processor 32 including a cache system, a main memory 34, a controller 4, an I/O unit 5, and a memory controller 6.

The cache system may have a layered structure or one-layer structure. The processor 32 issues an access request to the controller 4. The controller 4, as described above, transmits an access request to the memory controller 6 through the I/O unit 5. The memory controller 6, as described above with reference to FIG. 1 and the like, accesses the first memory 2 and the second memory 3 disposed inside the main memory 34.

In this way, according to this embodiment, all the data for which a write request from the controller 4 is present is written into the second memory 3, and a part of the data is written into the first memory 2 having a read speed higher than the second memory 3. Thereafter, when a read request from the controller 4 is present, a part of data for which the read request is present can be read from the first memory 2 at a high speed. Accordingly, by writing the critical data into the first memory 2, the speed at which the critical data is read can be improved.

In addition, in a case where the first memory 2 and the second memory 3 are arranged inside the main memory 34, by storing the critical data in the first memory 2, the access speed of the main memory 34 using the processor 32 can be improved.

While certain embodiments have been described, these embodiments have been presented by way of example only, and are not intended to limit the scope of the inventions, Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A memory control circuit comprising a memory controller that performs access control for a first memory accessed by a first data amount and access control for a second memory of a memory layer equal to the first memory at a read speed lower than a read speed of the first memory by a second data amount larger than the first data amount.

2. The memory control circuit according to claim 1, wherein the memory controller performs control of storing a part of data for which an access request is present in the first memory and performs control of storing the data for which the access request is present in the second memory.

3. The memory control circuit according to claim 1,
wherein the first data amount is one word including a plurality of bits; and
wherein the second data amount is n times the word, where n is an integer of two or more.

4. The memory control circuit according to claim 1, wherein the memory controller comprises:
a first memory controller that performs access control for the first memory accessed by the first data amount;
a second memory controller that performs access control for the second memory by the second data amount; and
an access controller that controls an access to the first memory controller or the second memory controller.

5. The memory control circuit according to claim 4, wherein the access controller comprises data determining circuitry that determines data to be stored in the first memory.

6. The memory control circuit according to claim 5, wherein the memory controller, based on a determination performed by the data determining circuitry, after storing a part of data for which a write request is present in the first memory or while storing the data in the first memory, performs control of storing the data in the second memory.

7. The memory control circuit according to claim 1, wherein, in a case where a part of data for which a read request is present is stored in the first memory, the memory controller performs control of reading the part from the first memory and performs control of reading the data for which the read request is present from the second memory.

8. The memory control circuit according to claim 7, wherein, in a case where a part of the data for which the read request is present is not stored in the first memory, the memory controller performs control of reading the data from the second memory.

9. The memory control circuit according to claim 1, further comprising a buffer maintaining data stored or data to be stored in the second memory,
wherein the memory controller performs control of at least one of write control and read control for the first memory and the buffer based on an access request from the controller.

10. The memory control circuit according to claim 9,
wherein the buffer is located inside the second memory, and
wherein the memory controller determines whether or not accessed data is maintained in the buffer and, in a case where the accessed data is maintained in the buffer, accesses the buffer located inside the second memory without accessing the first memory.

11. The memory control circuit according to claim 1, wherein data stored in the first memory includes word data to be transmitted first from a main memory.

12. The memory control circuit according to claim 1, wherein data stored in the first memory includes first word data of a page.

13. The memory control circuit according to claim 1, wherein data stored in the first memory includes first word data of data accessed in the past.

14. The memory control circuit according to claim 1, further comprising error detecting circuitry that performs error detection of data read from the first memory in the case of accessing the first memory,
wherein the memory controller sends the data read from the first memory to the controller in a case where an error is not detected by the error detecting circuitry and reads data for which a read request is present from the second memory and sends the read data to the controller in a case where an error is detected by the error detecting circuitry.

15. The memory control circuit according to claim 1, wherein a storable data capacity of the second memory is larger than a storable data capacity of the first memory.

16. The memory control circuit according to claim 1,
wherein the first memory comprises a magnetoresistive RAM (MRAM), and
wherein the second memory comprises a dynamic RAM (DRAM).

17. A storage device comprising:
a first memory accessed by a first data amount;
a second memory of a memory layer equal to the first memory at a read speed lower than a read speed of the first memory by a second data amount larger than the first data amount; and
a memory controller that performs access control for the first memory and the second memory.

18. The storage device according to claim 17, wherein the memory controller performs control of storing a part of data for which an access request is present in the first memory and performs control of storing the data for which the access request is present in the second memory.

19. The storage device according to claim 17, wherein the memory controller comprises:
a first memory controller that performs access control for the first memory accessed by the first data amount;
a second memory controller that performs access control for the second memory by the second data amount; and
an access controller that controls an access to the first memory controller or the second memory controller.

20. The storage device according to claim 19, wherein the access controller comprises data determining circuitry that determines data to be stored in the first memory.
